(19) United States
(12) Patent Application Publication
(10) Pub. No.: US 2005/0025587 A1
(43) Pub. Date: Feb. 3, 2005

(54) Optical lens hole drilling guider

(76) Inventor: Tony Xin Xiao, Walnut, CA (US)

Correspondence Address: Raymond Y. Chan, Suite 128, 108 N. Ynez Ave., Monterey Park, CA, 91754, US

(21) Appl. No.: 10/629,235

(22) Filed: Jul. 28, 2003

(51) Int. Cl. B23B 49/02; B23G 1/48; B23B 47/28

(52) U.S. Cl. 408/115 R

(57) ABSTRACT

An optical lens hole drilling guider includes a base member and a guiding member spacedly overlapped thereon to form a holding cavity for holding the optical lens in position. The guiding member includes first and second side guiders slidably mounted to each other for fitting a width of the optical lens and first and second guiding slots formed on the second side guider to communicate with the holding cavity. Therefore, when the optical lens is securely retained within the holding cavity, the second side guider is sidewardly slid from the first side guider until one of the first and second guiding slots is aligned with a marking point of the optical lens such that a drilling tool is adapted to penetrate the optical lens at the marking point through the respective guiding slot so as to form the through slot on the optical lens.

### BACKGROUND OF THE PRESENT INVENTION

1. Field of Invention

The present invention relates to an arrangement for forming a hole on an optical lens, and more particularly to an optical lens hole drilling guider which is adapted to precisely guide a drilling tool to form a hole on the optical lens.

2. Description of Related Arts

A conventional rimless spectacles comprises two optical lenses and a spectacle frame comprising a bridge having two ends directly mounted to two inner sides of the optical lenses respectively and two side extensions mounted to two outer sides of the optical lenses for coupling with two temples respectively.

In order to mount the spectacle frame to the optical lens to form the rimless spectacles, the optical lens contains a through hole formed thereon. For example, the through hole is formed at the inner side of the optical lens such that the bridge is capable of fastening to the optical lens through the through hole as a one-point connection. However, an unwanted movement of the bridge cannot be avoided due to the circular shape of the though hole. Therefore, nowadays, most optical lenses contain two through slots spacedly formed thereon to securely mount the spectacle frame as a two-point connection so as to prevent an unwanted movement thereof with respect to the optical lens.

Accordingly, there are three different configurations of the through slot formed on the optical lens. As shown in FIG. 1A, the two through slots, each having a circular shaped, are spacedly formed on the optical lens. FIG. 1B illustrates that one of the through slots having a circular shaped is formed on the optical lens while another through slots is formed at an edge portion of the optical lens. FIG. 1C illustrates that the through slots are combined to form an elongated through slot having a non-circular shape the optical lens.

In order to fittingly fasten the spectacle frame with the optical lens, the through slots must be precisely made on the optical lens. Therefore, a precise measuring apparatus is required to measure the position of each of the through hole on the optical lens before a drilling tool is operated to make the through hole on the optical lens. In other words, when the spectacles must be tailor made, the optical retail store will usually send the optical lens back to the optical company. So, the manufacturing cost of such rimless spectacles is extremely expensive because the manufacturing process for making the through hole on the optical lens is complicated and time consuming. Thus, if the through holes are misaligned with each other, the expensive optical lens cannot be re-used and must be disposed.

### SUMMARY OF THE PRESENT INVENTION

A main object of the present invention is to provide an optical lens hole drilling guider which is adapted to precisely guide a drilling tool to form a through slot on the optical lens.

Another object of the present invention is to provide an optical lens hole drilling guider, wherein the through slot can be selectively formed on the optical lens at a desired position and/or size such as on the optical lens, at the edge of the optical, or having an elongated shape. In other words, the optical lens hole drilling guider is adapted to provide different hole-configurations to fit the lens attachment.

Another object of the present invention is to provide an optical lens hole drilling guider, wherein the optical lens hole drilling guider can fit any size of the optical lens to precisely form a through slot thereon.

Another object of the present invention is to provide an optical lens hole drilling guider, wherein the guiding operation is quick and simple that by sliding the optical lens into the holding cavity between an upper guiding member and a lower supporting member, and then aligning a guiding slot on the guiding member with a marking point marked on the optical lens. Therefore, the drilling tool can penetrate through the marking point through the guiding slot to form the through slot on the optical lens. In other words, even the optical retail store is able to finish the lens hole operation without sending the optical lens back to the optical company so as to reduce the manufacturing cost of the spectacle.

Another object of the present invention is to provide an optical lens hole drilling guider, wherein the base supporting member has a curved shape to fittingly support the optical lens thereon so as to prevent an unwanted movement of the optical lens with respect to the optical lens hole drilling guider during the drilling operation.

Accordingly, in order to accomplish the above objects, the present invention provides an optical lens hole drilling guider for guiding an optical lens to form a though slot thereon, comprising:
a lower base member;
an upper guiding member spacedly overlapped on the base member to form a holding cavity therebetween for holding the optical lens in position, wherein the guiding member comprises first and second side guiders slidably mounted to each other in a side-by-side manner such that the second side guider is adapted to sidewardly slide with respect to the first side guider for fitting a width of the optical lens, the guiding member further having first and second guiding slots formed on the second side guider to communicate with the holding cavity wherein the first guiding slot is a circular through hole and the second guiding slot is an elongated through slot; and
a retaining device connecting the base member with the guiding member to selectively adjust a distance between the base member and the guiding member for securely retaining the optical lens within the holding cavity;
thereby, when the optical lens is securely retained within the holding cavity, the second side guider is sidewardly slid from the first side guider until one of the first and second guiding slots is aligned with a marking point of the optical lens such that a drilling tool is adapted to penetrate the optical lens at the marking point through the respective guiding slot so as to form the through slot on the optical lens.

These and other objectives, features, and advantages of the present invention will become apparent from the following detailed description, the accompanying drawings, and the appended claims.

### BRIEF DESCRIPTION OF THE DRAWINGS

FIGS. 1A to 1C illustrates the conventional hole-configuration of the optical lens.

FIG. 2 is a perspective view of an optical lens hole drilling guider according to a preferred embodiment of the present invention.

FIG. 3 is an exploded perspective view of the optical lens hole drilling guider according to the above preferred embodiment of the present invention.

FIG. 4 is a sectional view of the optical lens hole drilling guider according to the above preferred embodiment of the present invention.

FIG. 5 illustrates a guiding operation of the optical lens hole drilling guider according to the above preferred embodiment of the present invention.

### DETAILED DESCRIPTION OF THE PREFERRED EMBODIMENT

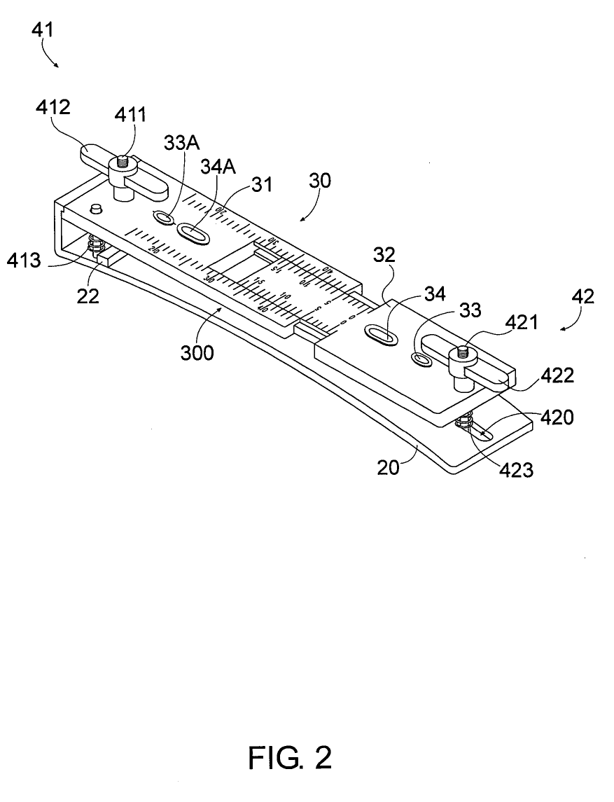

Referring to FIG. 2 of the drawings, an optical lens hole drilling guider for guiding a though slot 11 formed on an optical lens 10 according to a preferred embodiment of the present invention illustrated, wherein the optical lens hole drilling guider comprises a lower base member 20, an upper guiding member 30, and a retaining device 40.

The upper guiding member 30 is spacedly overlapped on the base member 20 to form a holding cavity 300 therebetween for holding the optical lens 10 in position, wherein guiding member 30 comprises first and second side guiders 31, 32 slidably mounted to each other in a side-by-side manner such that the second side guider 32 is adapted to sidewardly slide with respect to the first side guider 31 for fitting a width of the optical lens 10. The guiding member 30 further has first and second guiding slots 33, 34 formed on the second side guider 32 to communicate with the holding cavity 300 wherein the first guiding slot 33 is a circular through hole and the second guiding slot 34 is an elongated through slot.

The retaining device 40 is connecting the base member 20 with the guiding member 30 to selectively adjust a distance between the base member 20 and the guiding member 40 for securely retaining the optical lens 10 within the holding cavity 300. Therefore, a drilling tool T is adapted to penetrate the optical lens 10 retained within the holding cavity 300 through the respective guiding slot 33, 34 to form the through slot 11 on the optical lens 10.

According to the preferred embodiment, the base member 20 is constructed to have a predetermined curvature for substantially supporting the optical lens 10 thereon so as to enhance a contacting area of the base member 20 with respect to the optical lens 10. It is worth to mention that most of the optical lens 10 has a curved shape such that when the optical lens 10 is supported on the base member 20, the contacting area between the base member 20 and the optical lens 10 will be substantially increased, so as to ensure the optical lens 10 is held within the holding cavity 300 in position.

In order to prevent the scratch the optical lens 10 when the optical lens 10 is sandwiched between the base member 20 and the guiding member 30, the base member 20 further has a non-scratching upper surface 201 and the guiding member 30 further has a non-scratching bottom surface 301, wherein the non-scratching upper surface 201 of the base member 20 and the non-scratching bottom surface 301 of the guiding member 30 are arranged for contacting with a top side and a bottom side of the optical lens 10 respectively when the optical lens 10 is held within the holding cavity 300.

Accordingly, the non-scratching upper surface 201 of the base member 20 and the non-scratching bottom surface 301 of the guiding member 30 are made of non-scratching material, such as rubber piece, foaming layer, or silk layer, provided on an upper side of the base member 20 and a bottom side of the guiding member 30 respectively by coating or glue. It is worth to mention that the base member 20 can be shaped to form the non-scratching upper surface 201 having a convex shaped for biasing the optical lens 10 so as to enhance the contacting area therebetween.

The base member 20 further has an elongated guiding channel 21 formed thereon to align with the first and second guiding slots 33, 34 of the guiding member 30, wherein the guiding channel 21 is a through slot and has a predetermined length at least larger than a distance between the first and second guiding slots 33, 34 for allowing the drilling tool T passing through the base member 20 through the holding cavity 300. In other words, the drilling tool T penetrates the optical lens 10 through the respective guiding slot 33, 34 to form the through slot 11 on the optical lens 10 until the drilling tool T passes through the guiding channel 21 to complete the drilling operation, so that the drilling tool T will not damage the structure of the base member 20 during the drilling operation.

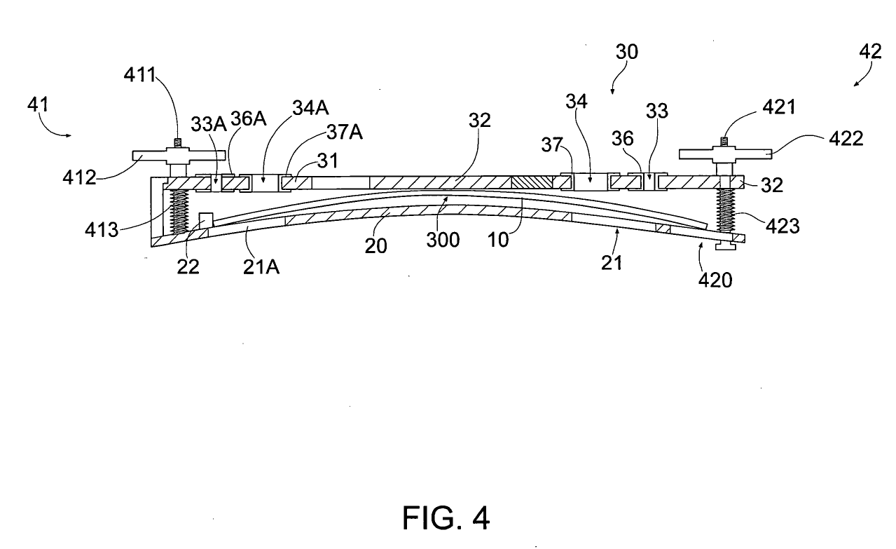

The base member 20 further comprises a lens blocker 22 disposed within the holding cavity 300 for blocking a sideward movement of the optical lens 10 within the holding cavity 300, wherein the lens blocker 32 is affixed on the base member 20 for biasing a side edge of said optical lens 10 to prevent a lateral movement of the optical lens 10 within the holding cavity 300. As shown in FIG. 4, when the optical lens 10 is held between the base member 20 and the guiding member 30 within the holding cavity 300, the side edge of the optical lens 10 is biased against the lens blocker 22 such that the sideward movement of the optical lens 10 is blocked by the lens blocker 22 so as to prevent an unwanted lateral movement of the optical lens 10 during drilling operation.

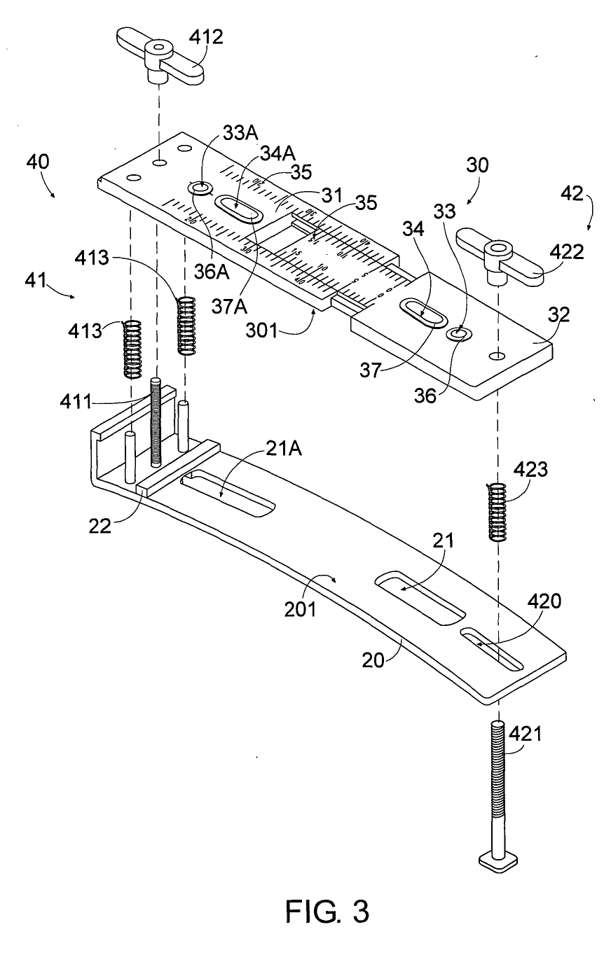

As shown in FIGS. 3 and 4, the guiding member 30 further has two corresponding measuring marker units 35 provided on the first and second side guiders 31, 32 respectively to provide a measuring length of the guiding member 30 for adjustably measuring the optical lens 10 held within the holding cavity 300. Accordingly, the measuring length of the guiding member 30 is selectively adjusted by sliding the second side guider 32 from the first side guider 31 to adjust the though slot 11 on the optical lens 10 aligning with the respective first and second guiding slot 33, 34.

Preferably, the guiding member 30 is made of transparent material such that when the optical lens 10 is held within the holding cavity 300, the optical lens 10 is capable of being seen from outside through the guiding member 30. Therefore, the operator is able to precisely position the optical lens 10 within the holding cavity 300 to align the optical lens 10 with the respective first and second guiding slot 33, 34.

The guiding member 30 further comprises two edge protectors 36, 37, each having a ring shaped, formed around the first and second guiding slots 33, 34 to protect edge walls of the first and second guiding slots 33, 34 respectively. Each of the edge protectors 36, 37 is made of rigid and durable material such as metal fittingly affixed to the edge wall of the respective first and second guiding slots 33, 34 so as to prevent an unwanted damage thereof when the drilling tool T passes through the respective first and the second guiding slot 33, 34.

The guiding member 30 further has third and fourth guiding slots 33A, 34A spacedly formed on the first side guider 31 to communicate with the holding cavity 300 wherein the third guiding slot 33A is a circular through hole and the fourth guiding slot 34A is an elongated through slot. It is worth to mention that the base member 20 further has an elongated additional guiding channel 21A formed thereon to align with the third and fourth guiding slots 33A, 34A of the guiding member 30A for guiding the drilling tool T to pass through the base member 20 through the additional guiding channel 21A.

Therefore, when the optical lens 10 is held within the holding cavity 300, the through slot 11 can be formed on either side of the optical lens 10 by penetrating the drilling tool T through the optical lens 10 through the respective first, second, third, and fourth guiding slot 33, 34, 33A, 34A. For example, when the optical lens 10 is used for the spectacles, two through slots 11 must be formed at two outer sides of the optical lens 10 respectively for fastening a bridge and an extension.

Therefore, the optical lens hole drilling guider is adapted to guide the drilling T to form one of the through slots 11 at one side of the optical lens 10 by penetrating the drilling tool T through the optical lens 10 through one of the first and second guiding slots 33, 34 and to form another through slots 11 at another side of the optical lens 10 by penetrating the drilling tool T through the optical lens 10 through one of the third and fourth guiding slots 33A, 34A.

The guiding member 30 should further comprises two additional edge protectors 36A, 37A, each having a ring shaped, formed around the third and fourth guiding slots 33A, 34A to protect edge walls of the third and fourth guiding slots 33A, 34A respectively.

As shown in FIG. 2, the retaining device 40 comprises a first locking unit 41 connecting the first side guider 31 with the base member 20 in a vertically movable manner to selectively adjust a distance between the base member 20 and the first side guider 31 and a second locking unit 42 connecting the second side guider 32 to selectively adjust a distance between the base member 20 and the second side guider 32.

The first locking unit 41 comprises a first guiding arm 411 upwardly extended from the base member 20 to slidably penetrate through the first side guider 31 and a first locking member 412 rotatably mounted on the first guiding arm 411 at a position above the first side guider 31 to lock up the first side guider 31 on the base member 20 so as to adjustably lock up the distance between the first side guider 31 and the base member 20. Accordingly, the first side guider 31 is overlappedly mounted on base member 20 in a vertically movable manner to adjust the height of the holding cavity 300.

The first locking unit 41 further comprises a first resilient element 413 disposed in the holding cavity 300 for applying an urging force against the first side guider 31. The first resilient element 413, according to the preferred embodiment, is a compression spring has two ends biasing against the base member 20 and the first side guider 31 respectively so as to upwardly push the first side guider 31 apart from the base member 20. The first resilient element 413 enhance the distance adjustment of the first side guider 31 with respect to the base member 20 because the first resilient element 413 provides an opposed upward urging force against the downward locking force of the first locking member 412 to finely adjust the distance between the first side guider 31 and the base member 20 so as to adjustably retain the optical lens 10 within the holding cavity 300 by means of clamping pressure.

The second locking unit 42 has an elongated groove 420 formed on the base member 20 and comprises a second guiding arm 421 having an elongated bottom portion positioned below the base member 20 and upwardly extended to slidably penetrate through the second side guider 32 through the elongated groove 420, and a second locking member 422 rotatably mounted to the second guiding arm 421 at a position above the second side guider 32 to lock up the second side guider 32 on the base member 20 so as to adjustably lock up the distance between the second side guider 32 and the base member 20.

According to the preferred embodiment, since the second side guider 32 is slidably mounted to first side guider 31, the second guiding arm 411 is arranged to slide along the elongated groove 420 until the through slot 11 of the optical lens 10 is aligned with the respective first and second guiding slot 33, 34. In other words, when the second side guider 32 is slidably extended from the first side guider 31, the second guiding arm 411 is driven to slide along the elongated groove 420 to fit the alignment of the through slot 11 of the optical lens 10.

The second locking unit 42 further comprises a second resilient element 423 disposed in the holding cavity 300 for applying an urging force against the second side guider 32. The second resilient element 423, according to the preferred embodiment, also is a compression spring coaxially mounted on the second guiding arm 421 and has two ends biasing against the base member 20 and the second side guider 32 respectively so as to upwardly push the second side guider 32 apart from the base member 20. Therefore, by individually adjust the distance between first side guider 31 and the base member 20 and the distance between the second side guider 32 and the base member 20, the optical lens 10 can be securely sandwiched between the guiding member 20 and the base member 20 by the clamping pressure so as to substantially retained within the optical lens 10 within the holding cavity 300.

It is worth to mention that the first side guider 31 is adapted to slide in a vertically movable manner via the first guiding arm 411 so as to selectively adjust the distance between the first side guider 31 and the base member 20. Thus, the second guider 32 is adapted to not only slide in a vertically movable manner via the second guiding arm 421 so as to selectively adjust the distance between the second side guider 32 and the base member 20 but also slide sidewardly from the first side guider 31 so as to selectively adjust the measuring length of the guiding member 30.

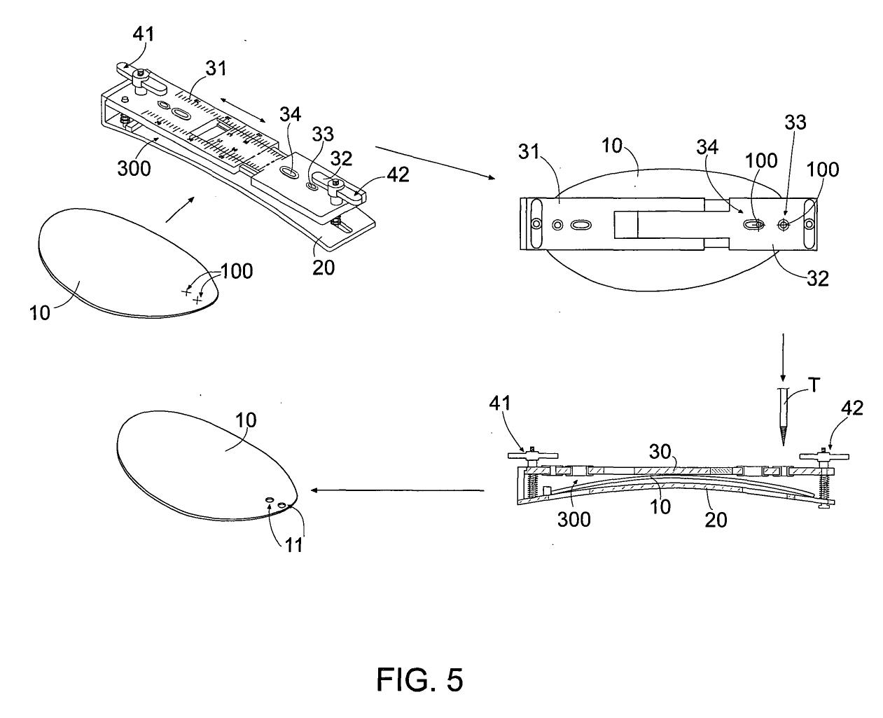

FIG. 5 illustrates the operation of the present invention. In order to operate the optical lens hole drilling guider of the present invention, the operator should form a marking point 100 on the optical lens 10 where the through slot 11 should be formed thereon. Then, the operator is able to slide the optical lens 10 to the holding cavity 300. By selectively adjusting the distances of the first and second side guiders 31, 32 with respect to the base member 20 via the first and second locking units 41, 42 respectively, the optical lens 10 is securely sandwiched between the guiding member 30 and the base member 20, so as to retain the optical lens 10 within the holding cavity 300.

Then, by adjustably sliding the second side guider 32 from the first side guider 31 until one of the first and second guiding slots 33, 34 is aligned with the marking point 100 of the optical lens 10, the drilling tool T is adapted to penetrate the optical lens 10 at the marking point 100 through the respective guiding slot 33, 34 so as to form the through slot 11 on the optical lens 10.

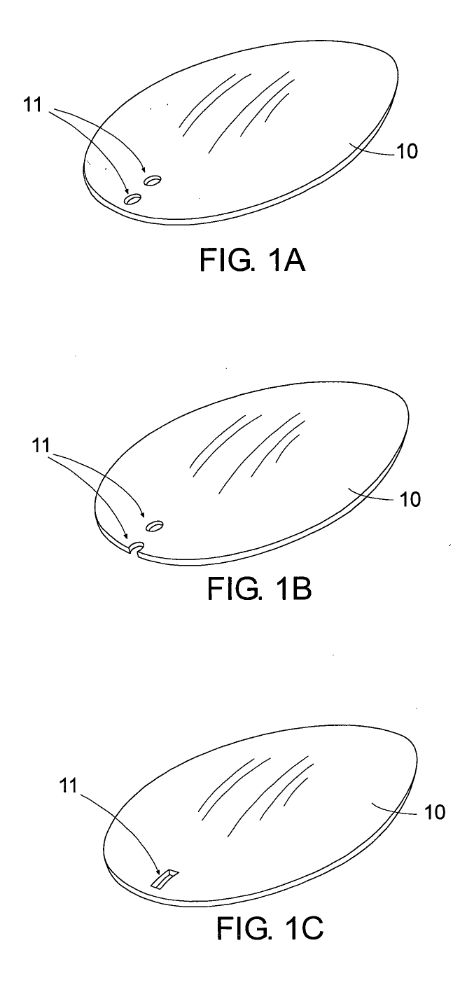

Accordingly, in order to make two through slots 11 on the optical lens 10, as shown in FIGS. 1A and 1B, two marking points 100 should be spacedly formed on the optical lens 10 to align with the first and second guiding slots 33, 34 respectively. It is worth to mention that the distance between the two marking points 100 can be the distance between the first and second guiding slots 33, 34 or the distance between two ends of the second guiding slots 34. For making the elongated through slot 11 on the optical lens, as shown in FIG. 1C, the marking point 100 should be formed on the optical lens 10 to align with the second guiding slot 34 such that the drilling tool T is adapted to form the elongated through slot 11 on the optical lens 10 along the second guiding slot 34.

In view of above, the guiding operation of the optical lens hole drilling guider is easy and simple that an individual is able to operate to form the through slots 11 on the optical lens 10. Thus, since the drilling tool T is guided to penetrate the optical lens 10 through the first and second guiding slots 33, 34, the two through slots 11 are precisely formed on the optical lens 10 without any pre-adjustment.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

1. An optical lens hole drilling guider for guiding an optical lens to form a through slot thereon, comprising:
a lower base member;
an upper guiding member spacedly overlapped on said base member to define a holding cavity therebetween for holding said optical lens in position, wherein said guiding member comprises first and second side guiders slidably mounted to each other in a side-by-side manner such that said second side guider is adapted to sidewardly slide with respect to said first side guider for fitting a width of said optical lens, wherein said guiding member further has first and second guiding slots formed on said second side guider to communicate with said holding cavity; and
a retaining device connecting said base member with said guiding member to selectively adjust a distance between said base member and said guiding member for securely retaining said optical lens within said holding cavity;
thereby, when said optical lens is securely retained within said holding cavity, said second side guider is sidewardly slid from said first side guider until one of said first and second guiding slots is aligned with a marking point of said optical lens such that a drilling tool is adapted to penetrate said optical lens at said marking point through said respective guiding slot so as to form said through slot on said optical lens.

2. The optical lens hole drilling guider, as recited in claim 1, wherein said base member has an elongated guiding channel formed thereon to align with said first and second guiding slots of said guiding member, wherein said guiding channel is a through slot and has a predetermined length at least larger than a distance between said first and second guiding slots for allowing said drilling tool passing through said base member through said holding cavity.

3. The optical lens hole drilling guider, as recited in claim 1, wherein said retaining device comprises a first locking unit connecting said first side guider with said base member in a vertically movable manner and a second locking unit which has an elongated groove formed on said base member and comprises a second guiding arm having an elongated bottom portion positioned below said base member and upwardly extended to slidably penetrate through said second side guider through said elongated groove, and a second locking member rotatably mounted to said second guiding arm at a position above said second side guider to lock up said second side guider on said base member so as to adjustably lock up a distance between said second side guider and said base member, wherein said second guiding arm is driven to slide along said elongated groove when said second side guider is slidably extended from said first side guider.

4. The optical lens hole drilling guider, as recited in claim 2, wherein said retaining device comprises a first locking unit connecting said first side guider with said base member in a vertically movable manner and a second locking unit which has an elongated groove formed on said base member and comprises a second guiding arm having an elongated bottom portion positioned below said base member and upwardly extended to slidably penetrate through said second side guider through said elongated groove, and a second locking member rotatably mounted to said second guiding arm at a position above said second side guider to lock up said second side guider on said base member so as to adjustably lock up a distance between said second side guider and said base member, wherein said second guiding arm is driven to slide along said elongated groove when said second side guider is slidably extended from said first side guider.

5. The optical lens hole drilling guider, as recited in claim 3, wherein said second locking unit further comprises a second resilient element disposed in said holding cavity for applying an urging force against said second side guider.

6. The optical lens hole drilling guider, as recited in claim 4, wherein said second locking unit further comprises a second resilient element disposed in said holding cavity for applying an urging force against said second side guider.

7. The optical lens hole drilling guider, as recited in claim 1, wherein said base member further has a non-scratching upper surface and said guiding member further has a non-scratching bottom surface, wherein said non-scratching upper surface of said base member and said non-scratching bottom surface of said guiding member are arranged for contacting with a top side and a bottom side of said optical lens respectively when said optical lens is held within said holding cavity.

8. The optical lens hole drilling guider, as recited in claim 3, wherein said base member further has a non-scratching upper surface and said guiding member further has a non-scratching bottom surface, wherein said non-scratching upper surface of said base member and said non-scratching bottom surface of said guiding member are arranged for contacting with a top side and a bottom side of said optical lens respectively when said optical lens is held within said holding cavity.

9. The optical lens hole drilling guider, as recited in claim 6, wherein said base member further has a non-scratching upper surface and said guiding member further has a non-scratching bottom surface, wherein said non-scratching upper surface of said base member and said non-scratching bottom surface of said guiding member are arranged for contacting with a top side and a bottom side of said optical lens respectively when said optical lens is held within said holding cavity.

10. The optical lens hole drilling guider, as recited in claim 7, wherein said base member is shaped to form said non-scratching upper surface having a convex shaped for biasing said optical lens to enhance a contacting area between said base member and said optical lens.

11. The optical lens hole drilling guider, as recited in claim 8, wherein said base member is shaped to form said non-scratching upper surface having a convex shaped for biasing said optical lens to enhance a contacting area between said base member and said optical lens.

12. The optical lens hole drilling guider, as recited in claim 9, wherein said base member is shaped to form said non-scratching upper surface having a convex shape for biasing said optical lens to enhance a contacting area between said base member and said optical lens.

13. The optical lens hole drilling guider, as recited in claim 1, wherein said guiding member further comprises two edge protectors, each having a ring shape, formed around said first and second guiding slots to protect edge walls of said first and second guiding slots respectively.

14. The optical lens hole drilling guider, as recited in claim 4, wherein said guiding member further comprises two edge protectors, each having a ring shape, formed around said first and second guiding slots to protect edge walls of said first and second guiding slots respectively.

15. The optical lens hole drilling guider, as recited in claim 9, wherein said guiding member further comprises two edge protectors, each having a ring shape, formed around said first and second guiding slots to protect edge walls of said first and second guiding slots respectively.

16. The optical lens hole drilling guider, as recited in claim 12, wherein said guiding member further comprises two edge protectors, each having a ring shape, formed around said first and second guiding slots to protect edge walls of said first and second guiding slots respectively.

17. The optical lens hole drilling guider, as recited in claim 1, wherein said guiding member further has two corresponding measuring marker units provided on said first and second side guiders respectively to provide a measuring length of said guiding member for adjustably measuring said optical lens held within said holding cavity, wherein said measuring length of said guiding member is selectively adjusted by sliding said second side guider from said first side guider for adjustably aligning said respective first and second guiding slot with said marking point on said optical lens.

18. The optical lens hole drilling guider, as recited in claim 9, wherein said guiding member further has two corresponding measuring marker units provided on said first and second side guiders respectively to provide a measuring length of said guiding member for adjustably measuring said optical lens held within said holding cavity, wherein said measuring length of said guiding member is selectively adjusted by sliding said second side guider from said first side guider for adjustably aligning said respective first and second guiding slot with said marking point on said optical lens.

19. The optical lens hole drilling guider, as recited in claim 12, wherein said guiding member further has two corresponding measuring marker units provided on said first and second side guiders respectively to provide a measuring length of said guiding member for adjustably measuring said optical lens held within said holding cavity, wherein said measuring length of said guiding member is selectively adjusted by sliding said second side guider from said first side guider for adjustably aligning said respective first and second guiding slot with said marking point on said optical lens.

20. The optical lens hole drilling guider, as recited in claim 16, wherein said first guiding slot is a circular through hole and said second guiding slot is an elongated through slot.

21. The optical lens hole drilling guider, as recited in claim 20, wherein said guiding member further has two corresponding measuring marker units provided on said first and second side guiders respectively to provide a measuring length of said guiding member for adjustably measuring said optical lens held within said holding cavity, wherein said measuring length of said guiding member is selectively adjusted by sliding said second side guider from said first side guider for adjustably aligning said respective first and second guiding slot with said marking point on said optical lens.

22. The optical lens hole drilling guider, as recited in claim 1, wherein said first guiding slot is a circular through hole and said second guiding slot is an elongated through slot.

23. The optical lens hole drilling guider, as recited in claim 22, wherein said guiding member further has third and fourth guiding slots formed on said first side guider to communicate with said holding cavity, wherein said third guiding slot is a circular through hole and said fourth guiding slot is an elongated through slot, wherein said third and fourth guiding slots are arranged for selectively aligning with said marking point of said optical lens to guide said drilling tool penetrating said optical lens at said marking point through said respective third and fourth guiding slot so as to form said through slot on said optical lens.

24. The optical lens hole drilling guider, as recited in claim 9, wherein said first guiding slot is a circular through hole and said second guiding slot is an elongated through slot.

25. The optical lens hole drilling guider, as recited in claim 24, wherein said guiding member further has third and fourth guiding slots formed on said first side guider to communicate with said holding cavity, wherein said third guiding slot is a circular through hole and said fourth guiding slot is an elongated through slot, wherein said third and fourth guiding slots are arranged for selectively aligning with said marking point of said optical lens to guide said drilling tool penetrating said optical lens at said marking point through said respective third and fourth guiding slot so as to form said through slot on said optical lens.

26. The optical lens hole drilling guider, as recited in claim 16, wherein said first guiding slot is a circular through hole and said second guiding slot is an elongated through slot.

27. The optical lens hole drilling guider, as recited in claim 26, wherein said guiding member further has third and fourth guiding slots formed on said first side guider to communicate with said holding cavity, wherein said third guiding slot is a circular through hole and said fourth guiding slot is an elongated through slot, wherein said third 10 and fourth guiding slots are arranged for selectively aligning with said marking point of said optical lens to guide said drilling tool penetrating said optical lens at said marking point through said respective third and fourth guiding slot so as to form said through slot on said optical lens.

28. The optical lens hole drilling guider, as recited in claim 20, wherein said first guiding slot is a circular through hole and said second guiding slot is an elongated through slot.

29. The optical lens hole drilling guider, as recited in claim 28, wherein said guiding member further has third and fourth guiding slots formed on said first side guider to communicate with said holding cavity, wherein said third guiding slot is a circular through hole and said fourth guiding slot is an elongated through slot, wherein said third and fourth guiding slots are arranged for selectively aligning with said marking point of said optical lens to guide said drilling tool penetrating said optical lens at said marking point through said respective third and fourth guiding slot so as to form said through slot on said optical lens.

30. The optical lens hole drilling guider, as recited in claim 9, wherein said base member further comprises a lens blocker disposed within said holding cavity for blocking a sideward movement of said optical lens within said holding cavity, wherein said lens blocker is affixed on said base member for biasing a side edge of said optical lens to prevent a lateral movement of said optical lens within said holding cavity.

31. The optical lens hole drilling guider, as recited in claim 16, wherein said base member further comprises a lens blocker disposed within said holding cavity for blocking a sideward movement of said optical lens within said holding cavity, wherein said lens blocker is affixed on said base member for biasing a side edge of said optical lens to prevent a lateral movement of said optical lens within said holding cavity.

32. The optical lens hole drilling guider, as recited in claim 25, wherein said base member further comprises a lens blocker disposed within said holding cavity for blocking a sideward movement of said optical lens within said holding cavity, wherein said lens blocker is affixed on said base member for biasing a side edge of said optical lens to prevent a lateral movement of said optical lens within said holding cavity.
